(19) United States
(12) Patent Application Publication
(10) Pub. No.: US 2007/0213189 A1
(43) Pub. Date: Sep. 13, 2007

(54) Paper folding apparatus with regulating speed and counting functions

(76) Inventor: Joseph Y. Ko, Laguna Niguel, CA (US)

Correspondence Address: BIRCH STEWART KOLASCH & BIRCH, PO BOX 747, FALLS CHURCH, VA, 22040-0747, US

(21) Appl. No.: 11/372,192

(22) Filed: Mar. 10, 2006

(51) Int. Cl. B31B 1/00

(52) U.S. Cl. 493/23

(57) ABSTRACT

A paper folding apparatus with regulating speed and counting functions includes a casing, a paper folding portion, a paper tray, at least one paper folding plate, a switch, a circuit board and an operation control portion which has a speed regulation means. The circuit board receives a signal detected by an inspection unit located in a paper discharge portion and outputs a counting signal displayed on a display unit. The circuit board further receives a signal from a reset control unit and sends a reset signal displayed on the display unit. The speed regulation means outputs a regulation signal to the circuit board which outputs a control signal to regulate the operation speed of the paper folding portion thereby to enhance paper folding quality and stability.

### FIELD OF THE INVENTION

The present invention relates to a paper folding apparatus and particularly to a paper folding apparatus that can regulate paper folding speed and count the number of paper articles.

### BACKGROUND OF THE INVENTION

The conventional paper folding apparatus mainly aim to perform bending, rolling and folding operations for paper articles such as envelopes, cards and bills in a fixed manner for binding. Reference can be found in prior art. One of them is R.O.C patent publication No. 528008 entitled “Automatic paper folding and pressing apparatus”. It has rollers to automatically direct, fold and press different types of paper to complete paper folding and pressing operations rapidly so that the paper can be fed in a neat fashion and discharged in a bent and folded manner.

Another R.O.C. patent publication No. 537192 entitled “Paper conveying structure for paper folding and sealing machines” includes a paper folding and sealing host with a paper conveying structure on one side. The paper conveying structure includes a chassis, a transmission mechanism, a clutch, and pawls. The clutch has two ends which can be engaged or disengaged to control paper conveying conditions of the pawls. There is a paper folding structure on an outer side of the paper conveying structure which has another set of chassis, transmission mechanism, clutch, pawls and a fender, a detent plate, forming rollers, and heating rollers to fold a lager size paper in half before directing into the paper conveying structure and host. It is suitable to stack paper and fold larger size paper.

However the conventional techniques set forth above cannot classify paper of different thickness. Papers that are too thick or too thin frequently jam in the paper folding apparatus and result in interruption of operation. Moreover, the conventional paper folding apparatus often have to process a great amount of paper articles. Quality control of counting the number of the paper articles is important. To do counting manually is error-prone.

### SUMMARY OF THE INVENTION

The primary object of the present invention is to solve the aforesaid disadvantages. The present invention provides a paper folding apparatus that can regulate paper folding speed and count paper articles. It includes a casing for holding a paper tray and a paper folding portion. The casing also has at least one paper folding plate on the paper folding portion, and two sides coupling with a paper feeding portion and a paper discharge portion. There is a bracket beneath the casing. The casing has a switch to control switching of a power supply and an operation control portion which contains a circuit board. The circuit board receives signals from an inspection unit of the paper discharge portion. The inspection unit is a sensor to detect the number of paper articles and output a signal to be displayed on a display unit. The paper feeding portion has a paper dispensing unit to do mechanical regulation according to the thickness of paper articles, and a reset control unit to send a signal to the circuit board and send a reset signal to be displayed on the display unit. The operation control portion has a regulation means to regulate paper folding speed. The regulation means can send a regulation signal to the circuit board which outputs a control signal to regulate the speed of the paper folding portion.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the invention.

FIG. 2 is a counting circuit block diagram of the invention.

FIG. 3 is a reset control circuit block diagram of the invention.

FIG. 4 is a speed regulation control circuit block diagram of the invention.

### DETAILED DESCRIPTION OF THE PREFERRED EMBODIMENTS

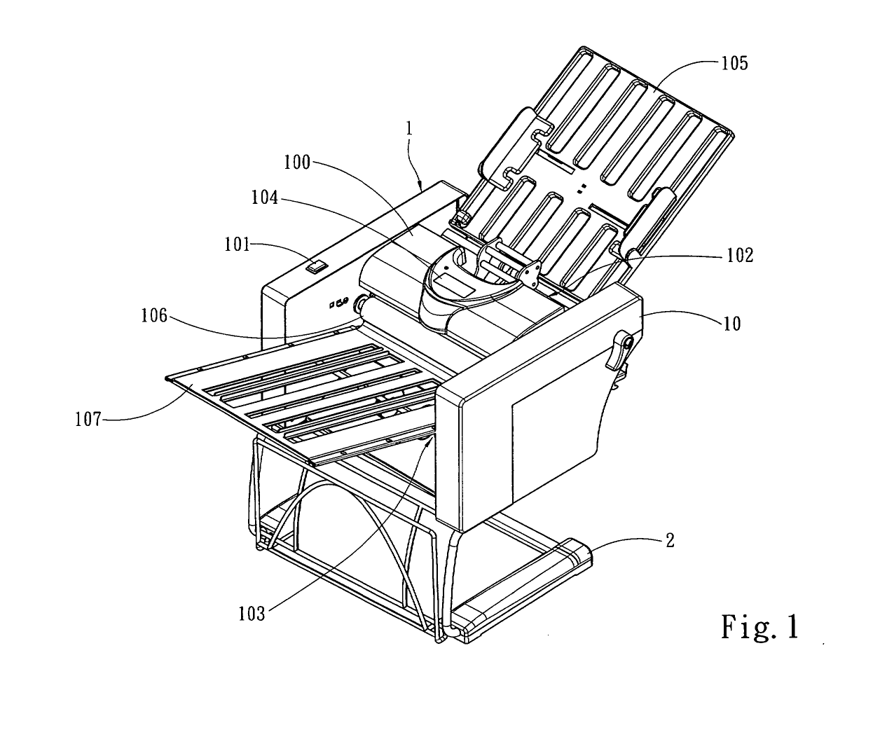

Please refer to FIG. 1, the paper folding apparatus 1 according to the invention includes a casing 10 which has a paper folding portion 106. The casing 10 has a paper feeding portion 102 and a paper discharge portion 103 on two sides to be coupled with the paper folding portion 106. The casing 10 further has a paper tray 105 on the paper feeding portion 102 and at least one paper folding plate 107 on the paper folding portion 106. The casing 10 also has a switch 101 to control switching of a power supply and an operation control portion 100 which has a display unit 104. In addition, there is a bracket 2 beneath the casing 1. The paper feeding portion 102 has a paper dispensing unit (not shown in the drawings) to do mechanical regulation according to the thickness of paper articles.

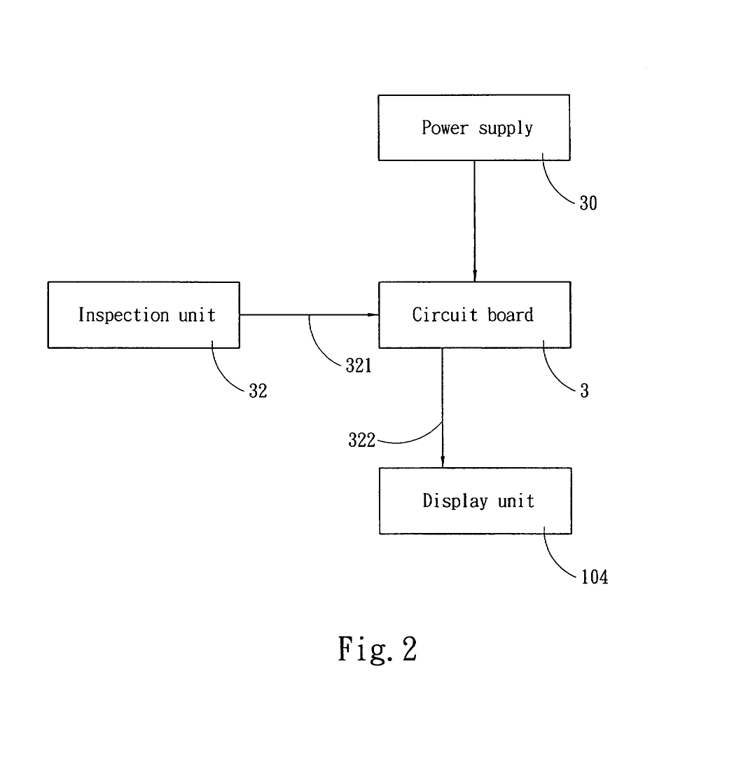

Refer to FIG. 2 for the counting circuit block diagram of the present invention. The operation control portion 100 has a circuit board 3. Through activation of the switch 101, a power supply 30 can provide electric power for the circuit board 3. When paper articles are mounted onto the paper tray 105, they are fed through the paper feeding portion 102. The fed paper articles are folded and pressed by the paper folding portion 106, then discharged through the paper discharge portion 103. Meanwhile, the paper discharge portion 103 has an inspection unit 32 (may be a sensor) to detect the number of the discharged paper articles. A detected counting data 321 is sent to the circuit board 3 which processes and outputs a counting signal 322 displayed on the display unit 104.

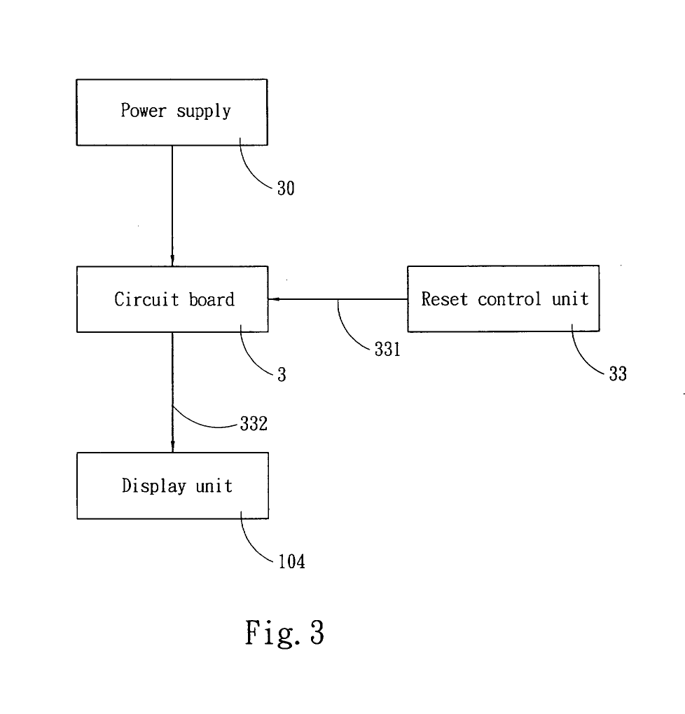

Refer to FIG. 3 for the reset control circuit block diagram of the present invention. The circuit board 3 receives a reset signal 331 from a reset control unit 33 and resets the original counting data to output a replacing signal 332 displayed on the display unit 104.

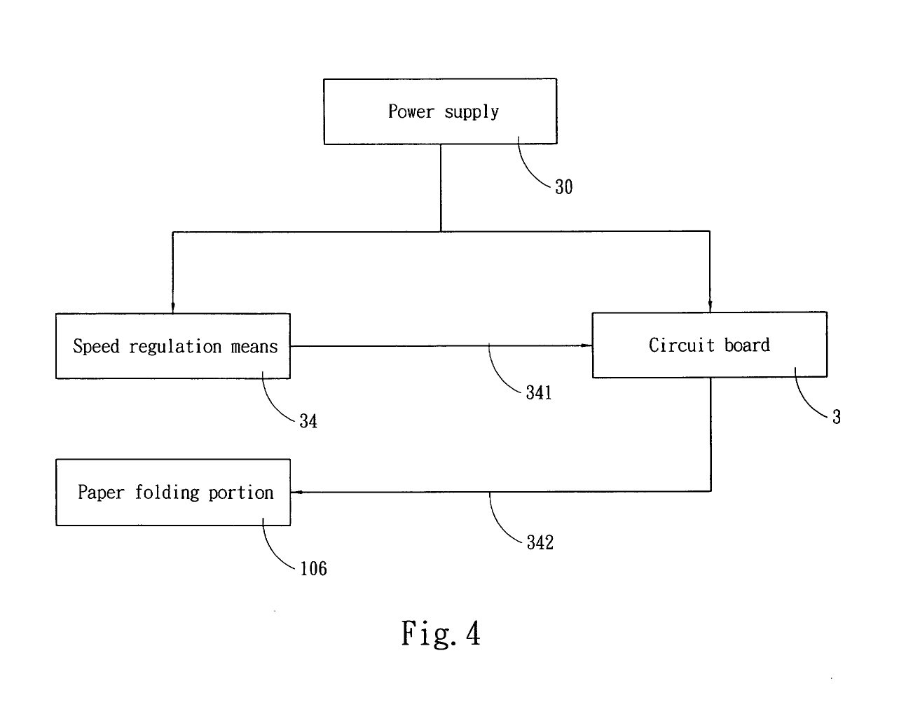

Refer to FIG. 4 for the speed regulation control circuit block diagram of the present invention. The operation control portion 100 has a speed regulation means 34. When the switch 101 is ON, the power supply provides electric power to drive the paper folding portion 106. The speed regulation means 34 can send a regulation signal 341 to the circuit board 3 which processes and outputs a control signal 342 to regulate the speed of the paper folding portion 106. The regulation signal 341 includes low speed regulation, medium speed regulation and high speed regulation to regulate the paper folding portion 106 to run at a low speed, a medium speed or a high speed.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A paper folding apparatus with regulating speed and counting functions, comprising:
a casing which has a switch to control switching of a power supply, a paper folding portion, a paper feeding portion and a paper discharge portion on two sides coupling with the paper folding portion, a paper tray on the paper feeding portion and at least one paper folding plate on the paper folding portion;
an operation control portion which is located in the casing and has a circuit board, the circuit board receiving a signal from an inspection unit located in the paper discharge portion and outputting another signal displayed on a display unit;
a rest control unit which sends yet another signal to the circuit board and a reset signal displayed on the display unit; and
a speed regulation means which is located in the operation control portion to regulate paper folding speed and output a regulation signal to the circuit board, the circuit board sending a control signal to regulate operation speed of the paper folding portion.

2. The paper folding apparatus of claim 1 further having a bracket beneath the casing.

3. The paper folding apparatus of claim 1, wherein the paper feeding portion has a paper dispensing unit.

4. The paper folding apparatus of claim 3, wherein the paper dispensing unit is a mechanical regulation means.

5. The paper folding apparatus of claim 1, wherein the inspection unit detects the number of paper articles.

6. The paper folding apparatus of claim 1, wherein the inspection unit is a sensor.
